(19) United States
(12) Patent Application Publication
(10) Pub. No.: US 2016/0285673 A1
(43) Pub. Date: Sep. 29, 2016

(54) CLIENT SIDE HOST MACHINE BACKUP SYSTEM AND ITS IMPLEMENTING METHOD

(71) Applicant: iCHEF Co., Ltd., Grand Cayman (KY)

(72) Inventor: Ming-Cheng HO, Taipei City (TW)

(21) Appl. No.: 14/805,091

(22) Filed: Jul. 21, 2015

(30) Foreign Application Priority Data
Mar. 25, 2015 (TW) 104109450

(51) Int. Cl. H04L 12/24; H04L 29/06

(52) U.S. Cl. CPC H04L 41/048; H04L 67/42

(57) ABSTRACT

A client side host machine backup system and its implementing method is provided, in which a cloud server is connected with a client side host machine in advance, and a number of client side slave machines, which perform exchange operation independently, are connected with the client side host machine by means of wireless transmission mode. After completing the exchange operation, each of the client side slave machines transmits the exchange data synchronously to the client side host machine, and the host machine uploads each exchange data, after archiving by the host machine to the cloud server for storage. When the host machine is out of order, the cloud server can assign one of the slave machines as the new client side host machine so as to continue the job done by the original client side host machine

### BACKGROUND OF INVENTION

1. Field of the Invention

The present invention relates to a client side host machine backup system and its implementing method, more particularly to a client side host machine backup system in which the cloud server can assign one of the client side slave machines as a new client side host machine so as to continue the job done by the original client side host machine, when the host machine is out of order.

2. Brief Description of the Prior Art

Referring to FIG. 1, a conventional client side host machine 10 is generally a single fixed machine, and the client side host machine 10 is in information connection with a cloud server 11 by a unified identification code (such as a fixed IP address), and the cloud server 11 recognizes the client side host machine 10 after registration with said unified identification code as the only host machine connecting therewith. In case that a single client side host machine 10 couples with additional one or several client side slave machines (12, 12′, 12″), each of all the client side slave machines (12, 12′, 12″) will send its independent transaction data to the client side host machine 10 firstly, and the transaction data after archived by the host machine 10 is transmitted through internet to the cloud server 11 for storage. However, in case the client side host machine 10 is out of order, the client side slave machines (12, 12′, 12″) are unable to transmit individual transaction data to the client side host machine 10, that means all the transaction data of the client side slave machines (12, 12′, 12″) cannot be uploaded by the client side host machine 10 to the cloud server 11 for storage.

### SUMMARY OF THE INVENTION

In view of the above problem, the main object of the present invention is provide a client side host machine backup system and its implementing method, in which the cloud server can assign one of the slave machines as the new client side host machine so as to continue the job done by the original client side host machine when it is out of order.

In order to achieve above object, the client side host machine backup system of the present invention is mainly formed by a cloud server, a client side host machine and a plurality of client side slave machines. The client side host machine in normal state is connected by internet with the cloud server and the plurality of client side slave machines. Each of the client side slave machines can be operated independently and its transaction data generated after operation is transmitted to the client side host machine, and the client side host machine further uploads the transaction data to the cloud server for storage, after the transaction data is received from each of the client side slave machines and archived by the client side host machine. When the client side host machine is out of order, the cloud server can assign one of the slave machines as a new client side host machine so as to avoid interruption of transaction data uploading and to continue the job done by the original client side host machine.

### BRIEF DESCRIPTION OF ACCOMPANYING DRAWINGS

FIG. 1 is a schematic view showing the operation of a conventional client side host machine;

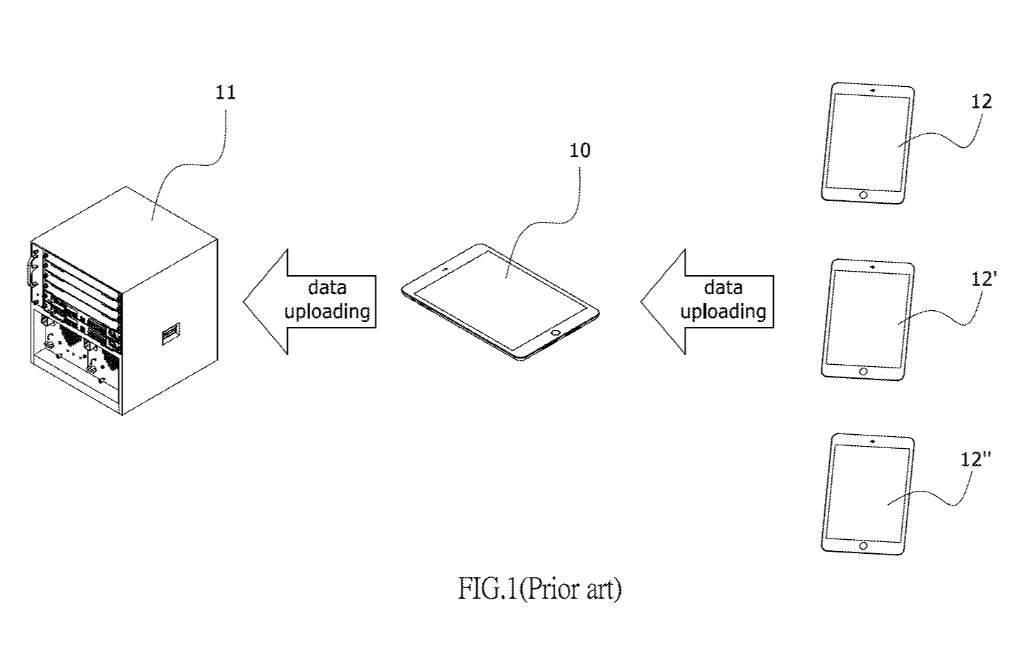

FIG. 2 is a schematic view showing the constitution of the system of the present invention;

FIG. 3 is a flow chart showing the implementation steps of the present invention;

FIG. 4 is view of implementation steps of another embodiment (I) of the present invention;

FIG. 5 is a schematic view of the embodiment (I) showing the implementation of the present invention;

FIG. 6 is view showing the implementation steps of another embodiment (II) of the present invention;

FIG. 7 is a schematic view of the embodiment (II) showing the implementation of the present invention.

### DETAILED DESCRIPTION OF PREFERRED EMBODIMENTS

The objects, the technical contents and the expected effectiveness of the present invention will become more apparent from the detailed description of a preferred embodiment in conjunction with the accompanying drawings.

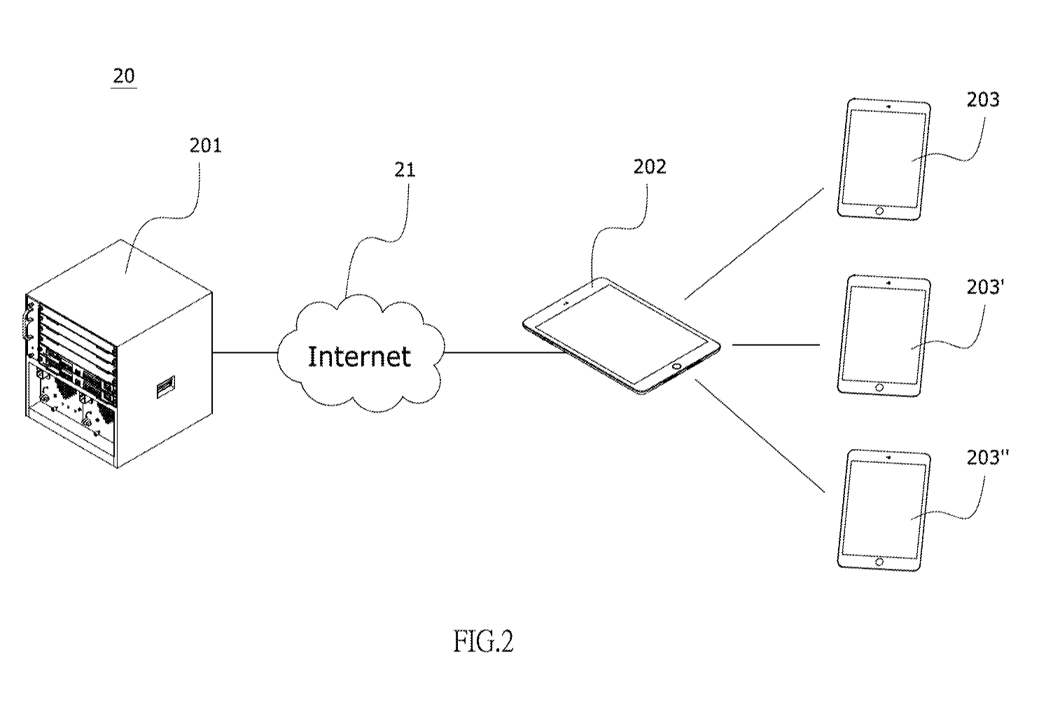

Referring to FIG. 2, the client side host machine backup system 20 of the present invention is mainly formed by a cloud server 201, a client side host machine 202 and a plurality of client side slave machines (203, 203′, 203″). The client side host machine 202 is connected through an internet, such as a wireless network, with the cloud server 201. Further, after the connecting between the client side host machine 202 and the cloud server 201 is completed, the client side slave machines (203, 203′, 203″) are respectively connected with the client host machine 202. Each of the client side slave machines (203, 203′, 203″) can be operated independently, and each of the client side slave machines (203, 203′, 203″) can transmit its transaction data to the client side host machine 202, and the client side host machine 202 archives the transaction data and further uploads the transaction data through the internet 21 to the cloud server 201 for storage.

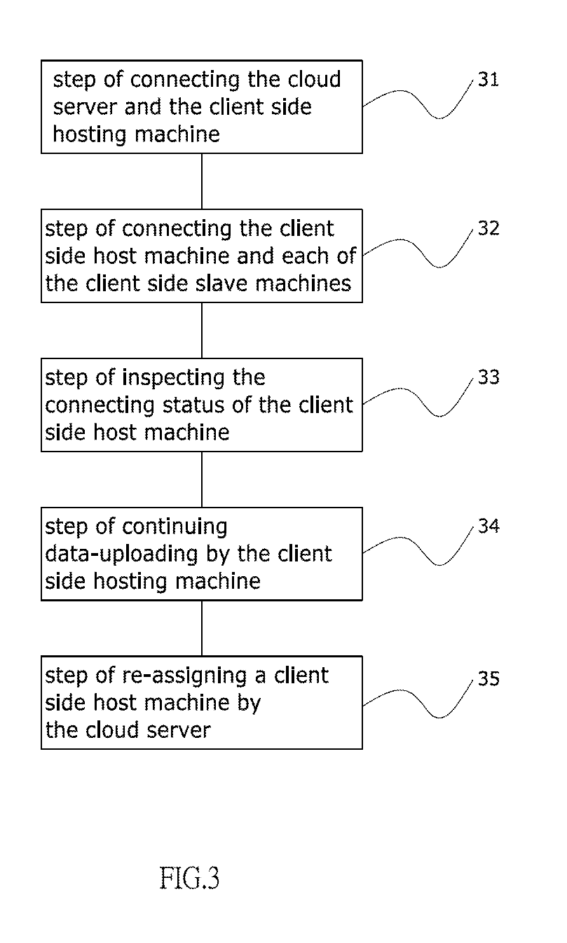

Referring to FIG. 3 and FIG. 2, the implementation steps of the present invention will be described as below.

(1) a step 31 of connecting the cloud server and the client side host machine: after the client side host machine 202 completes the connection and registration with the cloud server 201 by a unified identification code (such as a fixed IP address), the cloud server 201 recognizes the client side host machine 202 having said unified identification code as the only host machine connecting therewith;

(2) a step 32 of connecting the client side host machine and each of the client side slave machine: after the connection between the cloud server 201 and the client side host machine 202 is completed, the client side host machine 202 announces to each of the client side slave machines (203, 203′, 203″) within the same group that the host machine itself is recognized, by the cloud server 302 after registration, as the host machine enabling the transmission of transaction data, so that each of the client side slave machine (203, 203′, 203″) can connect with the client side host machine 202 through wireless transmission mode. Each of the client side slave machines (203, 203′, 203″) can perform transaction operation independently, and the data generated after transaction is transmitted to the client side host machine 202 for storage. Furthermore, the cloud server 201 can also connect with the client side slave machine firstly booted among the client side slave machines (203, 203′, 203″) so as to allow this client side slave machine serving as the host machine enabling transaction data transmission.

(3) a step 33 of inspecting the connection status of the host machine: the cloud server 201 or each of the client side slave machines (203, 203′, 203″) continuously monitor whether the connecting status of the client side host machine 202 is normal or not. If normal, then go to step 34; if abnormal, then go to step 35.

(4) a step 34 of continuing data-uploading from the client side host machine: when the connecting status of the client side host machine 202 is normal, each of the client side slave machines (203, 203′, 203″) continuously transmits the transaction data by wireless mode to the client side host machine 202 for storage, and then the client side host machine 202 archives and then uploads the transaction data to the cloud server 201 for storage;

(5) a step 35 of re-assigning a client side host machine by the cloud server: when the original client side host machine 202 is out of order to cause off-line (interruption), one of the client side slave machines (203, 203′, 203″) automatically connect with the cloud server 201 through registration by a unified identification code so that this client side slave machines can be immediately converted into a new client side host machine, and thus backup function is achieved. Alternatively, the cloud server 201 also can assign directly one of the client side slave machines (203, 203′, 203″) as the new client side host machine.

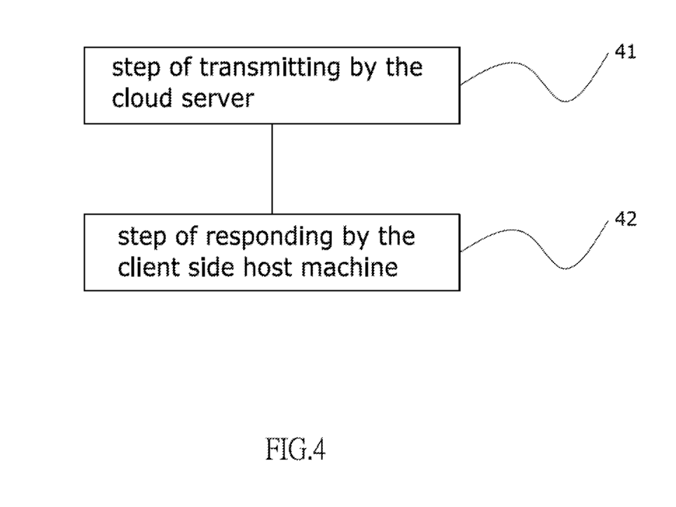

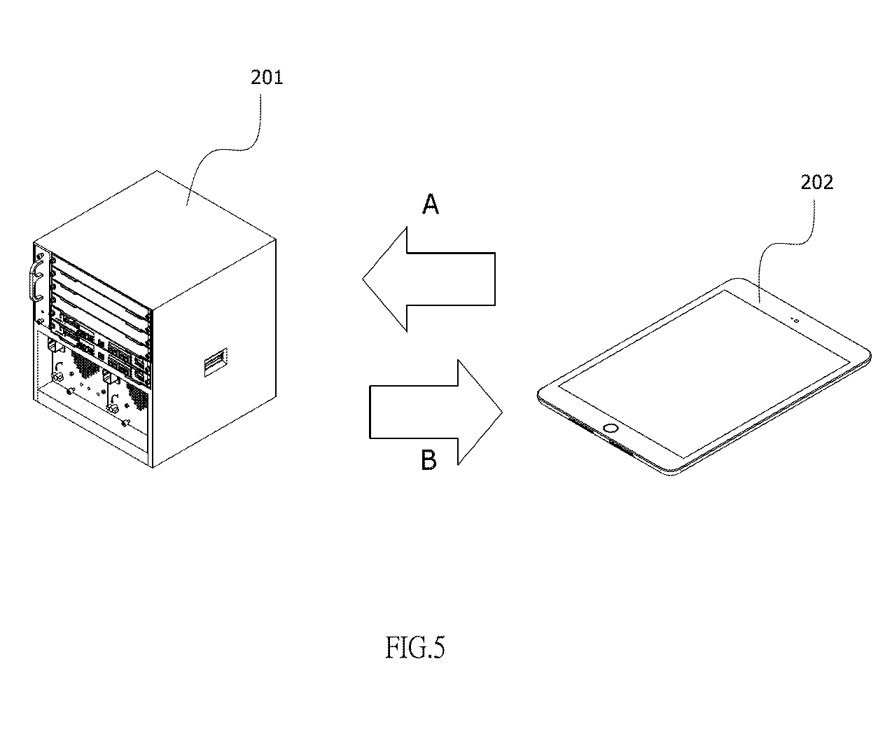

Referring to FIG. 4 and FIG. 3, following the step 33 of inspecting the connection status of the host machine, the confirmation step of inspecting whether the connecting status between the cloud server 201 and the client side host machine 202 is normal or not will be described as below. By the way, please also refers to FIG. 5 which is a schematic view of the embodiment (I) showing the implementation of the present invention.

(1) a step 41 of transmitting signal by the cloud server : the cloud server 201 in normal state continuously (definite timing or indefinite timing) transmits a query signal A to the client side host machine 202 to confirm whether the connecting status of the host machine is normal or not;

(2) a step 42 of responding signal by the client side host machine: following the step 41, the client side host machine 202 transmits a response signal B immediately back to the cloud server 201, when the client side host machine 202 receives the query signal A, so that the cloud server 201 can judge the current connecting status of the client side host machine 202 is normal, and then go to the step 34. On the other hand. If no response from the client side host machine 202 is made with respect to the query signal A came from the cloud server 201, then the cloud server 201 can judge the current connecting status of the client side host machine 202 is abnormal, and then go to the step 35 in which the action of re-assigning a new client side host machine is made.

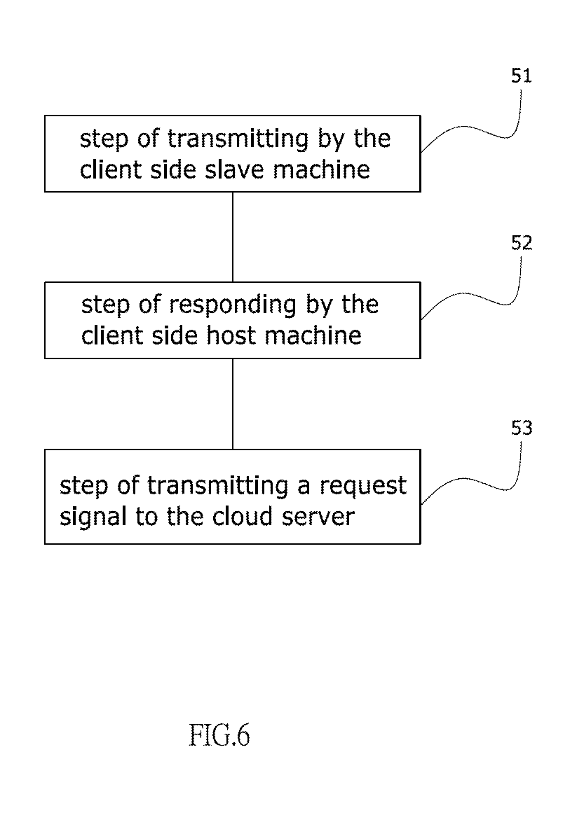

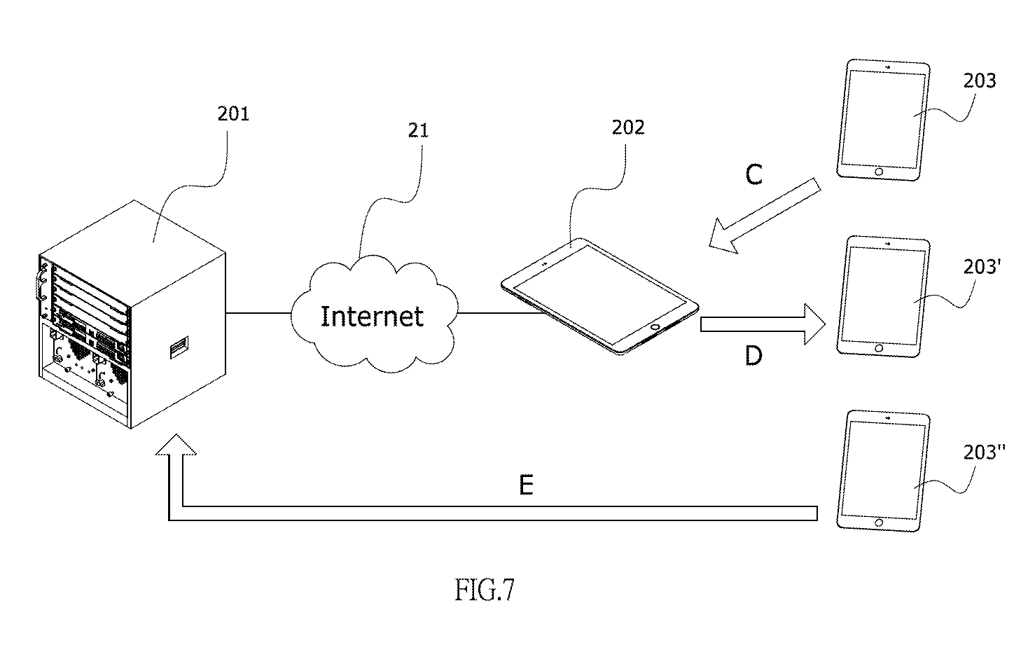

Referring to FIG. 6, following the step 33 of inspecting connection status of the host machine in FIG. 3, the confirmation step of inspecting whether the connecting status between the client side host machine 202 and each of the client side slave machines (203, 203′, 203″) is normal or not will be described as below. At the same time, please also refer to FIG. 7 which is a schematic view of the embodiment (II) showing the implementation of the present invention.

(1) a step 51 of transmitting signal by the client side slave machine:

one of the client side slave machines (203, 203′, 203″) will randomly transmits a query signal C in definite timing or indefinite timing to the client side host machine 202 so as to confirm whether the connecting status of the host machine is normal or not;

(2) a step 52 of responding signal by the client side host machine: the client side host machine 202 transmits a response signal D immediately back to the client side slave machine that transmitted the query signal C, when the client side host machine 202 receives the query signal C, so that this client side slave machine can judge the current connecting status of the client side host machine 202 is normal, and then go to the step 34. On the other hand, if no response is made with respect to the query signal C, then go to the step 53;

(3) a step 53 of transmitting request signal to cloud server: when the client side host machine 202 has no response, it is judged to be in failure state, and the client side slave machine that transmitted the query signal C transmits a request signal E through the internet 21 to the cloud server 201, and then go to the step 35.

Based on foregoing, the client side host machine backup system and its implementing method of the present invention can monitor the connecting status of the client side host machine by the cloud server and the client side slave machines, and the cloud server can assign one of the slave machines as the new client side host machine, when the original client side host machine is out of order. Summing up above, the present invention, after implementation according to the abovementioned, surely can achieve the object of providing a client side host machine backup system and its implementing method, in which the cloud server can assign one of the slave machines as the new client side host machine so as to continue the job done by the original client side host machine when it is out of order.

While the present invention has been described by preferred embodiments in conjunction with accompanying drawings, it should be understood the embodiments and the drawings are merely for descriptive and illustrative purpose, not intended to restrict the scope of the present invention. Equivalent variations and modifications conducted by persons skilled in the art without departing from the spirit and scope of the present invention should be considered to be still within the scope of the present invention.

What is claimed is:

1. A client side host machine backup system, comprising:
at least one or more client side slave machines, which can be operated independently and which generate transaction data after each operation is finished;
a client side host machine, which is in information connection with each of the client side slave machines and receives the transaction data generated by each of the client side slave machines;
a cloud server, which is connected with the client side host machine after a registration being made with a unified identification code, and which receives the uploading of transaction data came from the client side host machine after the client side host machine receives and archives the transaction data from each of the client side slave machines;
wherein, the cloud server can assign one of several client side slave machines as new client side host machine so as to continue the operation of the whole system, when the client side host machine is out of order.

2. The client side host machine backup system as claimed in claim 1, wherein the internet is a wireless network.

3. The client side host machine backup system as claimed in claim 1, wherein the unified identification code is a fixed IP address.

4. An implementation method of client side host machine backup system, comprising:
a step of connecting the cloud server and the client side host machine: a client side host machine completes the connection and registration with a cloud server by a unified identification code;
a step of connecting the client side host machine and each of the client side slave machine: the client side host machine announces to each of the client side slave machine within the same group that the host machine itself is recognized, by the cloud server after registration, as the host machine enabling the transmission of transaction data, so that each of the client side slave machines can transmit its transaction data to the client side host machine after it is connected with the client side host machine through wireless transmission mode;
a step of inspecting connection status of the host machine: The cloud server continuously monitors the connecting status of the client side host machine;
a step of continuing data-uploading from the client side host machine: following the step of inspecting connection status of the host machine, when the connecting status of the client side host machine is normal, the client side host machine archives and then uploads the transaction data to the cloud server for storage;
a step of re-assigning a client side host machine by the cloud server: following the step of inspecting connection status of the host machine, when the connecting status of the client side host machine is abnormal, one of the client side slave machines automatically connect with the cloud server through registration by its IP address so that this client side slave machine can be immediately converted into a new client side host machine, and thus backup function is achieved.

5. The implementation method of client side host machine backup system as claimed in claim 4, wherein the step of inspecting connection status of the host machine comprises:
a step of transmitting signal by the cloud server: the cloud server in normal state continuously transmits a query signal to the client side host machine;
a step of responding signal by the client side host machine : the client side host machine transmits a response signal immediately back to the cloud server, when the client side host machine receives the query signal, so that the cloud server can judge the current connecting status of the client side host machine is normal, and then go to the step of continuing data-uploading of the client side host machine; conversely. If no response is made with respect to the query signal came from the cloud server, then the cloud server can judge the current connecting status of the client side host machine is abnormal, and then go to the step of re-assigning a new client side host machine.

6. The implementation method of client side host machine backup system as claimed in claim 4, wherein the step of inspecting connection status of the host machine comprises:
a step of transmitting signal by the client side slave machine: one of the client side slave machines will continuously transmit a query signal to the client side host machine;
a step of responding signal by the client side host machine: the client side host machine transmits a response signal immediately back to the client side slave machine which transmitted the query signal, when the client side host machine receives the query signal, so that the client side slave machine can judge the current connecting status of the client side host machine is normal, and then go to the step of continuing data-uploading of the client side host machine;
a step of transmitting request signal to cloud server: when the client side host machine has no response, it is judged to be in failure state, and the client side slave machine which transmitted the query signal transmits a request signal through the internet to the cloud server, and then go to the step of re-assigning a new client side host machine.

7. The implementation method of client side host machine backup system as claimed in claim 4, wherein, in the step of re-assigning a new client side host machine by the cloud server, the cloud server can directly assign one of the client side slave machines as a new client side host machine

8. The implementation method of client side host machine backup system as claimed in claim 4, wherein, the unified identification code used in the step of connecting the cloud server and the client side host machine is a fixed IP address.
